(19) United States
(12) Patent Application Publication
(10) Pub. No.: US 2006/0032597 A1
(43) Pub. Date: Feb. 16, 2006

(54) Control method and an adjustment method and a control arrangement and an adjustment arrangement for a fibre web machine

(75) Inventors: Eero Suomi, Hameenlinna (FI); Matti Tervonen, Hyvinkaa (FI)

Correspondence Address: COHEN, PONTANI, LIEBERMAN & PAVANE, 551 FIFTH AVENUE, SUITE 1210, NEW YORK, NY, 10176, US

(73) Assignee: Metso Paper Inc., Helsinki (FI)

(21) Appl. No.: 10/534,305

(22) PCT Filed: Sep. 9, 2004
(86) PCT No.: PCT/FI04/00521

§ 371 Date: Jun. 3, 2005

(30) Foreign Application Priority Data
Sep. 10, 2003 (FI) 20031293

(51) Int. Cl. D21F 11/00; G06F 7/66; D21G 1/00

(52) U.S. Cl. 162/198; 162/263; 700/128

(57) ABSTRACT

The object of the invention is a control and an adjustment method for the fibre web machine. According to the invention—an emitting voice is measured continuously at least from one section of the fibre web machine and frequency bands (df) and/or the combinations of the frequency bands and amplitudes of the same, which correlate state and change of different process values, are separated measuring signals (fₘ);—the measuring signals are compared with reference signals (f_{ref}), which correlate an ideal state or a desired state; and—control signals are generated from deviations of the measuring signals and reference signal (f_{A}), by which control signals the measured process values are returned closer to the ideal state or the desired state.

The present invention relates to fibre web machines as to paper, cardboard, tissue and chemical pulp and similar fibre web machines. The object of the invention out in more detail is a control method and adjustment method and a control arrangement and adjustment arrangement that are in accordance with the introduction part of the patent claim 1 for the fibre web machine especially for an optimisation of the control and adjustment of calendering process.

Traditionally in a processing line of a fibre, such as the fibre web machine, typically are the control parameters and adjustment parameters different and measured values, for example pressure values, temperature values, speed values, surface values, mass values, the vibration values and humidity/dryness values, which are back fed and/or forward connected for controlling and adjusting the process. It is also previously known that it is possible to measure voice or the noise that is emitting from the processing line in order to resolve the dominating state.

It is after knowing that the voice measuring or noise measuring do not indicate the state of individual process stages or the condition of the machine parts of the fibre web machine as such in a more detailed manner for controlling and adjusting the same.

The object of the present invention is to accomplish new and inventive control method and adjustment method as well as a control arrangement and adjustment arrangement for the fibre web machine. The invention is based on the applicant's insight that it is possible to utilise the voice measuring and noise measuring in the control and adjustment of the fibre web machine, because processing of the fibre web emits in all processing conditions acoustic voice or noise that can be measured, and because, the force and frequency distribution and the spectrum of the emitted voice or noise depend on the driving speed, on the properties of the fibre web, which runs in the fibre web machine, on the temperature, moisture and load and for example condition of the calender rolls, drying rolls or press rolls.

The object of the present invention in question has been reached with the control method and adjustment method and with the control arrangement and adjustment arrangement, which has been mentioned in the beginning, the special characteristics of which have been disclosed in the enclosed set of claims.

It characteristic to the invention according to the control method and adjustment method of the invention generally that voice or noise that is emitting from at least from one section of the fibre web machine is measured continuously and frequency bands and/or combinations of the frequency bands and the corresponding amplitudes thereof, which correlate state and change of different process values, are separated from the received measuring signals, that the measuring signals are compared with reference signals, which correlate ideal state or desired state, and that from deviations f the measuring signals and reference signal are formed control signals, by means of which the measured process values are returned closer to the ideal state or the desired state.

It is advantageous that, for resolving the deviation and for forming the control signal, the measuring signal is back fed in the control system.

According to an advantageous embodiment of the present invention it is measured sound or noise from a calendering machine of the fibre web machine by means of a voice sensor.

It is characteristic of a control arrangement and adjustment arrangement, which is in accordance with the invention, generally that a constant measuring of voice or noise has been arranged at least in one section of the fibre web machine, that a measuring signal, which correlates state and change of a process value, is in an optional frequency band and/or in an optional combination of frequency bands, and that a control signal is formed by comparing the measuring signal with the reference signal, which correlates ideal state or desired state, in which case the control signal can be formed by means of deviation of the measuring signals and a reference signal, by means of which control signal the process value can be returned closer to the ideal state or the desired state.

It is advantageous for managing the deviation that the measuring signal is back fed.

In the control arrangement and adjustment arrangement, which is in accordance with the invention, one can change step by step the control signal of the regulating unit, which control signal has been accomplished by means of the measuring signal and reference signal of the fibre web machine or evenly in relation to time or periodically.

In one embodiment form of the invention, the emitted voice or the noise has been measured by means of a voice sensor from the calendering machine of the fibre web machine.

One can mention about the advantages of the invention that the invention can be adapted to the adjustment and control of all the process values of the processing of the fibre web. The most typical controllable process values are;
Rotation speeds of rolls,
Line loads,
Hydraulics pressures,
Track tightness,
Temperatures, especially temperatures of thermo rolls
Humidity and moistening amounts of the fibre web,
Evaporation amounts.

The invention is described in the following only as an example by means of an advantageous embodiment form, for which the present invention has naturally not been meant to be limited and by referring to the enclosed drawing, in which

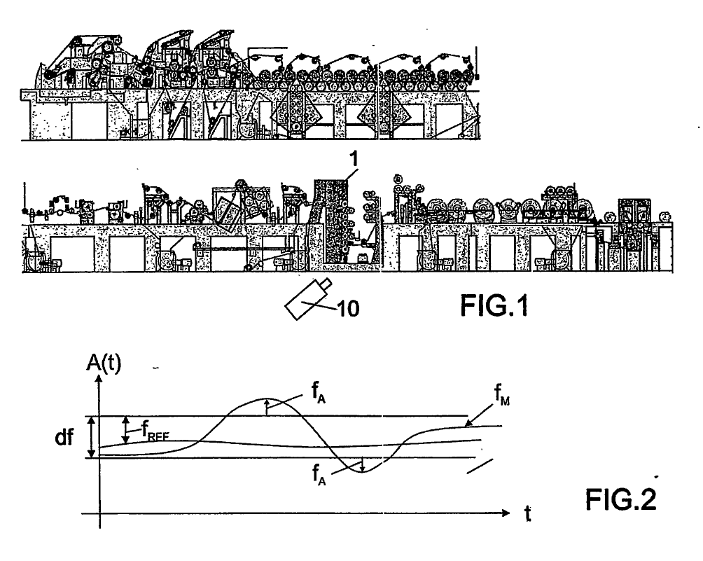

FIG. 1 presents diagrammatically a paper machine, which represents the fibre web machine, and

FIG. 2 presents the measuring signal, from which there are distinguished two frequency bands for accomplishing the control signal that is in accordance with the invention.

There is disclosed in the FIG. 1 a paper machine that comprises a formation part A of the fibre web, pressing part B, drying part C, covering part D, calendering part E in which multi-roll calendering machine 1 and reeling part are F has been presented in FIG. 1.

The invention can be adapted to the adjustment and control of the process values of the processing of the fibre web in any given part of the fibre web machine, the A . . . E. The most typical controllable process values are;
Rotation speeds of rolls,
Line loads,
Hydraulics pressures,
Track tightness,
Temperatures, especially temperatures of thermo rolls
Humidity and moistening amounts of the fibre web,
Evaporation amounts.

In the following, the control method and adjustment method and adjustment arrangement for the fibre web machine, which are in accordance with the invention, are explained, only the in the connection of the calendering machine of the paper machine.

Reference is made to FIGS. 1 and 2. In the embodiment of the FIG. 1, the voice or the noise emitting from the paper machine is measured, advantageously, continuously by means of a voice sensor 10 from at least one section of the paper machine. Especially advantageous is that the emitting voice or the noise is measured from the calendering machine of the paper machine. After this it is separated from the received measuring signals fₘ, frequency bands df and/or combinations of the frequency bands as well as and their amplitude variation on the frequency in question, which correlate the state and change of different process values,

Then the received measuring signals are compared with reference signals f_{REF}, which correlate ideal state or desired state, and deviations f_{A} of the reference signals f_{REF} and the measuring signals fₘ are formed control signals by means of which the measured process values are returned closer to the ideal state or the room or the desired state. In order to resolve reference signals f_{A} of the deviations and in order to form the control signal it is advantageous according to a preferred application example of the invention that the measuring signal fₘ is back fed. Hence it becomes possible that the control signal to be accomplished may change stepwise or in relation to time evenly or periodically.

Reference is made to the FIG. 2, which presents the change of the frequency of the voice as a function of the time. As in FIG. 2 it is shown, there are the three essentially similarly repeating describers that illustrate the changes of the frequency of the voice in relation to time, the higher describer of which describes the measuring signal fₘ and the lower of which describes the reference signal (f_{REF}) that correlates the ideal state or the desired state. Both describers reach to the frequency band df, whereby by means of the deviation df of the measuring signal and the reference signal it becomes possible to form the control signal, by which a measured process value can be returned closer to the ideal state or the desired state.

Accounts have been given of the invention only with the help of an advantageous embodiment. As it is evident to any skilled in the art, modifications and equivalent alternatives are possible within the inventive idea that has been defined in the enclosed patent claims.

1. A control method and an adjustment method for a fibre-web machine, characterized in that voice or noise that is emitting from at least from one section of the fibre web machine is measured continuously and frequency bands (df) and/or combinations of the frequency bands and the corresponding amplitudes thereof, which correlate state and change of different process values, are separated from the received measuring signals (fₘ), that the measuring signals are compared with reference signals (f_{ref}), which correlate ideal state or desired state, and that from deviations (f_{A}) of the measuring signals and reference signal are formed control signals, by means of which the measured process values are returned closer to the ideal state or the desired state.

2. A control method and an adjustment method, which is in accordance with patent claim 1, characterized in that for resolving the deviation (f_{A}) and for forming the control signal the measuring signal (fₘ) is back fed in control system it.

3. A control method and an adjustment method, which is in accordance with patent claim 1, characterized-in that emitting voice or noise is measured by means of a voice sensor from a calendaring machine of the fibre web machine.

4. A control arrangement and an adjustment arrangement for a fibre web machine, characterized in that a constant measuring of voice or noise has been arranged at least in one section of the fibre web machine, that a measuring signal (fₘ), which correlates state and change of a process value, is in an optional frequency band (df) and/or in an optional combination of frequency bands, and that a control signal is formed by comparing the measuring signal with the reference signal (f_{ref}), which correlates ideal state or desired state, in which case the control signal can be formed by means of deviation of the measuring signals and a reference signal (f_{A}), by means of which control signal the process value can be returned closer to the ideal state or the desired state.

5. A control arrangement and an adjustment arrangement, which is in accordance with patent claim 4, characterized in that in order to resolve the deviation (f_{A}) and to form the control signal the measuring signal (fₘ) is back fed in control system.

6. A control arrangement and an adjustment arrangement, which is in accordance with patent claim 4, characterized in that the provided control signal (fₘ) of a function assembly changes stepwise.

7. A control arrangement and an adjustment arrangement, which is in accordance with patent claim 4, characterized in that the provided control signal (fₘ) of a function assembly changes evenly in relation to the time.

8. A control arrangement and an adjustment arrangement, which is in accordance with patent claim 4, characterized in that the provided control signal (fₘ) of a function assembly changes evenly in relation to the time.

9. A control arrangement and an adjustment arrangement, which is in accordance with patent claim 4 characterized in that the emitted voice or the noise has been measured from a calendering machine by means of a voice-measuring sensor.

10. A control method and an adjustment method, which is in accordance with patent claim 2, characterized-in that emitting voice or noise is measured by means of a voice sensor from a calendaring machine of the fibre web machine.

11. A control arrangement and an adjustment arrangement, which is in accordance with patent claim 5, characterized in that the provided control signal (fₘ) of a function assembly changes stepwise.

12. A control arrangement and an adjustment arrangement, which is in accordance with patent claim 5, characterized in that the provided control signal (fₘ) of a function assembly changes evenly in relation to the time.

13. A control arrangement and an adjustment arrangement, which is in accordance with patent claim 5, characterized in that the provided control signal (fₘ) of a function assembly changes evenly in relation to the time.

14. A control arrangement and an adjustment arrangement, which is in accordance with patent claim 5 characterized in that the emitted voice or the noise has been measured from a calendering machine by means of a voice-measuring sensor.

15. A control arrangement and an adjustment arrangement, which is in accordance with patent claim 6 characterized in that the emitted voice or the noise has been measured from a calendering machine by means of a voice-measuring sensor.

16. A control arrangement and an adjustment arrangement, which is in accordance with patent claim 7 characterized in that the emitted voice or the noise has been measured from a calendering machine by means of a voice-measuring sensor.

17. A control arrangement and an adjustment arrangement, which is in accordance with patent claim 8 characterized in that the emitted voice or the noise has been measured from a calendering machine by means of a voice-measuring sensor.
